(19) United States
(12) Patent Application Publication
(10) Pub. No.: US 2008/0098070 A1
(43) Pub. Date: Apr. 24, 2008

(54) SYSTEM FOR ADDING NEW RECIPIENTS TO E-MAIL THREAD

(75) Inventors: Niklas Heidloff, Salzkotten (DE); Shruti Kumar, Littleton, MA (US); Michael R. O'Brien, Westford, MA (US); Patrick J. O'Sullivan, Ballsbridge (IE)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/551,394

(22) Filed: Oct. 20, 2006

(51) Int. Cl. G06F 15/16

(52) U.S. Cl. 709/206; 709/204

(57) ABSTRACT

A system for adding new recipients to an e-mail thread. The system includes a server device configured to administer an electronic mail (E-MAIL) application. At least one client device being operably associated via a network with the server device. The at least one client device configured to add new E-MAIL recipients to the E-MAIL thread of the distributed E-MAIL message via a user interface (UI) having a menu selection for adding recipients to the thread. The UI being operably associated with the client device and the server device. The client device is further configured to add the identity of the new E-MAIL recipient to a persistent store table located on the client device.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to electronic mail (E-MAIL), and more particularly, to adding new recipients to E-MAIL thread.

2. Description of Background

Nowadays, a lot of business communication is carried on via E-MAIL. Knowledge workers and executives rely heavily on this form of communication. In so called E-MAIL threads multiple people can have discussions by replying with new E-MAILS to everyone in the thread (all people in the “to” and the “cc” field). Often in these E-MAILS new people are added to the thread. This is important if in the discussion it becomes obvious that the owner of the problem is not part of the thread yet. Another case when people are added to a thread is when the people in the thread need more information from other experts in order to make a decision.

As long as a thread does not branch and everyone responds sequentially to the last E-MAIL of the thread, people can be added easily to a thread by them to the “to” or “cc” field of a new mail as a response to everyone in the thread. However, very often people that are added to the thread don't actually see all responses from other people to the thread. This can happen in the following scenarios, basically whenever a branch occurs:
(1) Person A in the thread adds a new person B to the thread, but person A doesn't respond to the last mail of the thread and in the meantime the thread has already gone on however without person B being copied.
(2) Even if person B was added to the last mail of the thread, a person C could respond to the thread based on another previous mail in which person B was not included yet.

Thus, there is a need for a system that allows a person to be added to the entire mail thread and not just to one branch of the thread as in current systems.

### SUMMARY OF THE INVENTION

The shortcomings of the prior art are overcome and additional advantages are provided through the provision of a system for adding new recipients to an e-mail thread. The system includes a server device being configured to administer an electronic mail (E-MAIL) application. At least one client device is operably associated via a network with the server device. The at least one client device is configured to add new E-MAIL recipients to the E-MAIL thread of the distributed E-MAIL message via a user interface (UI) having a menu selection for adding recipients to the thread. The UI is operably associated with the client device and the server device. The client device is further configured to add the identity of the new E-MAIL recipient to a persistent store table located on the client device.

Additional features and advantages are realized through the techniques of the present invention. Other embodiments and aspects of the invention are described in detail herein and are considered a part of the claimed invention. For a better understanding of the invention with advantages and features, refer to the description and to the drawing.

### TECHNICAL EFFECTS

As a result of the summarized invention, technically we have achieved a solution for a system for adding new recipients to an e-mail thread.

### BRIEF DESCRIPTION OF THE DRAWINGS

The subject matter regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a system for adding new recipients to an e-mail thread, in accordance with the disclosed invention;

FIG. 2 illustrates one example of a thread and its member table for the system shown in FIG. 1; and

FIG. 3 illustrates one example of the thread and the updated member table shown in FIG. 2.

The detailed description explains the preferred embodiments of the invention, together with advantages and features, by way of example with reference to the drawing.

### DETAILED DESCRIPTION OF THE INVENTION

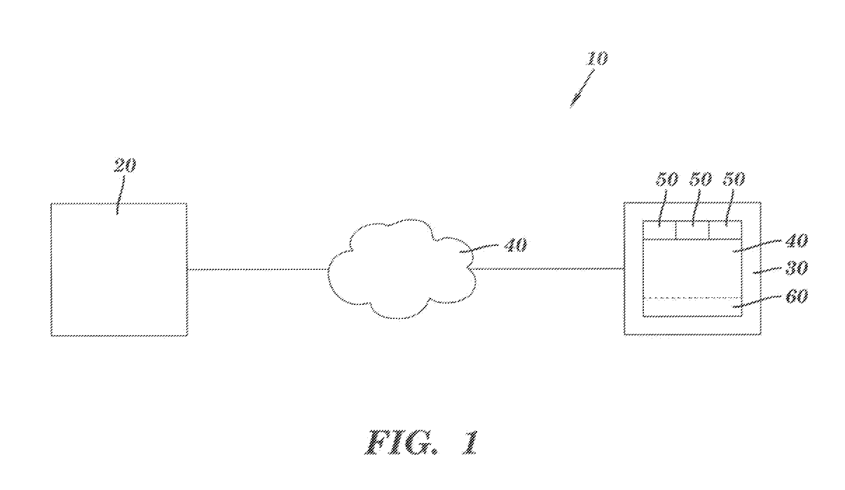

Referring to FIG. 1, a system 10 for adding new recipients to an e-mail thread is shown. The system 10 includes a server device 20 that is configured to administer an electronic mail (E-MAIL) application.

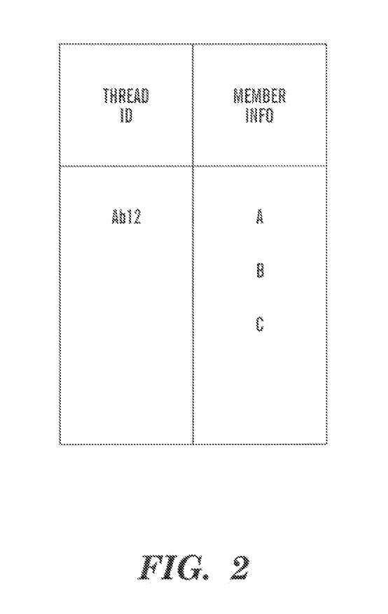

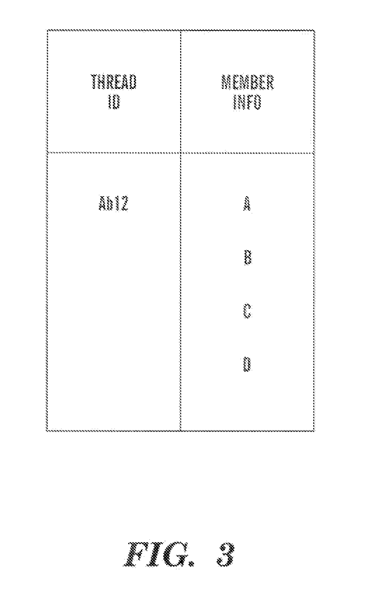

Referring to FIGS. 1-3, at least one client device 30 is operably associated via a network 40 with the server device 20. The at least one client device 30 is configured to add new E-MAIL recipients to the E-MAIL thread of the distributed E-MAIL message via a user interface (UI) 40 having a menu selection 50 for adding recipients to the thread. The UI 40 is operably associated with the client device 30 and the server device 20. The client device 30 is further configured to add the identity of the new E-MAIL recipient to a persistent store table 60 located on the client device 30. The client device 30 is further configured to check whether all the desired recipients are incorporated in the thread that should be incorporated predicated upon the persistent store table 60. The client device 30 is further configured to prompt the user that some desired recipient in the thread wanted to add another recipient to the thread provided the client device 30 determines that certain recipients are missing. The sender of the thread may choose at least one of the following options, (i) to add the missing desired recipient to the thread, and (ii) send the thread without adding the desired recipient. The thread includes at least one of, (i) e-mail, and (ii) calendaring.

The persistent store table 60 is configured to contain all the recipients that may be involved on new responses to the thread. The persistent store table 60 includes two forms of data, (i) the thread id, and (2) the recipients that should be involved on the E-MAIL. The persistent store table 60 is updated whenever new e-mail arrives on the client device 30.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for adding new recipients to an e-mail thread, comprising:
a server device configured to administer an electronic mail (E-MAIL) application;
at least one client device operably associated via a network with the server device, the at least one client device configured to add new E-MAIL recipients to the E-MAIL thread of the distributed E-MAIL message via a user interface (UI) having a menu selection for adding recipients to the thread, the UI operably associated with the client device and the server device; and
wherein the client device is further configured to add the identity of the new E-MAIL recipient to a persistent store table located on the client device.

2. The system of claim 1, wherein the persistent store table is configured to contain all the recipients that may be involved on new responses to the thread.

3. The system of claim 2, wherein the persistent store table includes two forms of data, (i) the thread id, and (2) the recipients that should be involved on the E-MAIL.

4. The system of claim 3, wherein the client device is further configured to check whether all the desired recipients are incorporated in the thread that should be incorporated predicated upon the persistent store table.

5. The system of claim 4, wherein the client device is further configured to prompt the user that some desired recipient in the thread wanted to add another recipient to the thread provided the client device determines that certain recipients are missing.

6. The system of claim 5, wherein the sender of the thread may choose at least one of, (i) to add the missing desired recipient to the thread, and (ii) send the thread without adding the desired recipient.

7. The system of claim 6, wherein the persistent store table is updated whenever a new e-mail arrives on the client device.

8. The system of claim 7, wherein the thread includes at least one of, (i) e-mail, and (ii) calendaring.
